(19) United States
(12) Patent Application Publication
(10) Pub. No.: US 2010/0273006 A1
(43) Pub. Date: Oct. 28, 2010

(54) THERMOSETTING POLYMERS

(75) Inventors: Klin A. Rodrigues, Signal Mountain, TN (US); Matthew Keur, Harrison, TN (US)

Correspondence Address: AKZO NOBEL INC., LEGAL & IP, 120 WHITE PLAINS ROAD, SUITE 300, TARRYTOWN, NY, 10591, US

(73) Assignee: Akzo Nobel N.V., Arnhem (NL)

(21) Appl. No.: 12/746,877

(22) PCT Filed: Dec. 18, 2008
(86) PCT No.: PCT/EP08/67871

§ 371 Date: Jun. 8, 2010

Related U.S. Application Data
(60) Provisional application No. 61/016,374, filed on Dec. 21, 2007.

(51) Int. Cl. C08L 29/04; B05D 3/10; B32B 17/10; B32B 27/38

(52) U.S. Cl. 428/417; 427/385.5; 427/393; 427/389.8; 427/393.6; 524/503; 428/413

(57) ABSTRACT

Polymeric thermosetting systems that are formaldehyde free binder systems and composites utilizing such systems include a formaldehyde free binder formed one or more hydroxyl polymers and one or more hydroxyl polymer crosslinkers.

This application claims priority to U.S. Provisional Patent Application Ser. No. 61/016,374 filed on Dec. 21, 2007, which is incorporated herein by reference in its entirety.

### FIELD OF THE INVENTION

The present invention relates to thermosetting polymers or formaldehyde free binder systems containing a hydroxy polymer and a hydroxy polymer crosslinker. The present invention also relates to composites produced using such formaldehyde free binder systems, as well as a process for producing these composites.

### BACKGROUND OF THE INVENTION

Synthetic polymers are used in a wide variety of applications. In many applications, these synthetic polymers are crosslinked in order to achieve the required performance properties. For over sixty years a large class of commercially important thermoset polymers has utilized formaldehyde-based crosslinking agents. Such crosslinking agents based on formaldehyde traditionally have provided an efficient and cost-effective binder to produce a variety of composite materials. Examples of formaldehyde-based crosslinking agents include melamine-formaldehyde, urea-formaldehyde, phenol-formaldehyde and acrylamide-formaldehyde adducts. With growing toxicity and environmental concerns, there has been an ongoing search to replace formaldehyde-based crosslinking systems. However, these alternative systems have suffered from significant deficiencies including high cost, low or slow cure, requiring end users to change their commercial high speed application equipment, emission of toxic components or volatile organic compounds other than formaldehyde, lack of moisture resistance, lack of adequate binding between the binder and the substrate, and low pH needed to cure the binder leading to corrosion issues in the production equipment.

Traditional formaldehyde free binders systems typically do not perform as well as a formaldehyde-based thermoset resins. Furthermore, traditional formaldehyde free binders systems such as those based on polyacrylic acid cure at a low pH (e.g., less than three), which can result in corrosion issues in the process equipment. There is a need, therefore, for formaldehyde free binder systems that can cure at a pH greater than three, even in the neutral pH range.

Some formaldehyde free binder systems use ammonium salts of small molecule carboxylic acids as crosslinking agents. These systems have emission issues such as the release of ammonia. Therefore, there is a need for formaldehyde free binder systems that limit or minimize emission issues such as the release of ammonia. Other formaldehyde free binders systems substitute aldehydes such as glyoxal for formaldehyde in binder systems. Unfortunately, most aldehydes including glyoxal have toxicological and environmental issues. Therefore, there is a need for formaldehyde free binders systems that do not use aldehyde crosslinkers.

### SUMMARY OF THE INVENTION

In one embodiment, the present invention provides for composite produced using a formaldehyde free binder system and a mineral wool or lignocellulosic substrate. These formaldehyde free binders are a mixture of a hydroxy polymer and a hydroxy polymer crosslinker. In another embodiment, the present invention provides for a process for producing these composites by depositing a mixture of a hydroxy polymer and a hydroxy polymer crosslinker on to a mineral wool or lignocellulosic substrate and curing the treated substrate.

### DETAILED DESCRIPTION OF THE INVENTION

For purposes of this invention, a composite is an article of manufacture or a product formed by treating a substrate with a formaldehyde free binder. Substrates useful in this invention include materials such as mineral wool and lignocellulosic substrates. The formaldehyde free binder can be applied to the substrate, for example, in the form of an aqueous solution and cured to form the composite.

For the purposes of this invention, mineral wool means fibers made from minerals or metal oxides, which may be synthetic or natural and includes fiberglass, ceramic fibers, mineral wool and rockwool (also known as stone wool). Mineral wool is an inorganic substance used for insulation and filtering. Materials like fiberglass and ceramic fibers are mineral wools by virtue of their consisting of minerals or metal oxides.

When the substrate is fiberglass, the fiberglass composites produced may be useful as insulation for heat or sound in the form of rolls or batts or loose-fill insulation; as a reinforcing mat for roofing and flooring products such as ceiling tiles and flooring tiles; as a microglass-based substrate for printed circuit boards and battery separators; for filter stock and tape stock; and for reinforcements in both non-cementatious and cementatious masonry coatings.

For the purposes of this invention, a “lignocellulosic substrate” is defined as lignocellulosic raw materials for producing lignocellulosic composites such as wood, flax, hemp, and straw, including wheat, rice and barley straw but not cellulosic fibers such as those used to make paper. In one aspect, the lignocellulosic substrate is wood. The lignocellulosic substrate can be processed into any suitable form and size, including various particles or fragments such as chips, flakes, fibers, strands, wafers, trim, shavings, sawdust, and combinations thereof. The binder can be deposited on the lignocellulosic substrate and cured to form a lignocellulosic composite. Lignocellulosic composites produced using the present formaldehyde-free binders include particleboard, ply-wood, oriented strand board (OSB), waferboard, fiberboard (including medium-density and high-density fiberboard), parallel strand lumber (PSL), laminated strand lumber (LSL), laminated veneer lumber (LVL), and similar products.

“Formaldehyde free binders” according to the present invention have at least one or more hydroxy polymers and one or more hydroxy polymer crosslinkers. “Formaldehyde free binders” means that the binder is substantially formaldehyde free in that it contains ingredients that have a total formaldehyde content of about 100 ppm or less. In an embodiment of the invention, the formaldehyde free binders do not contain any ingredients that have formaldehyde, in which case the formaldehyde free binders are referred to as “completely formaldehyde free binders.” For the purpose of the present invention, “hydroxy polymers” are any synthetic polymers containing a hydroxyl group. Such hydroxy polymers include, for example, homopolymers and copolymers containing vinyl alcohol functionalities, as well as polymers containing hydroxy alkyl(meth)acrylates moieties such as hydroxyethyl acrylate or hydroxypropyl methacrylate. However, the hydroxy polymers do not include small molecule polyols such as sorbitol, glycerol, propylene glycol, etc. A mixture of hydroxy polymers may also be used and, depending upon the system, may provide a beneficial effect.

Crosslinkers useful in this invention are referred to as hydroxy polymer crosslinkers. The terms “hydroxy polymer crosslinker” and “crosslinker” may be used interchangeably in this disclosure. For the purpose of this invention, “hydroxy polymer crosslinkers” include any material that can react with a hydroxy polymer or its derivatives to form two or more bonds. These bonds include but are not limited to covalent, ionic, hydrogen bonds or any combination thereof.

The hydroxy polymers have a number of hydroxyl groups able to react with the functional groups on the hydroxy polymer crosslinkers. Examples of useful hydroxy polymer crosslinkers include adipic/acetic mixed anhydride, epichlorohydrin, sodium trimetaphosphate, sodium trimetaphosphate/sodium tripolyphosphate, acrolein, phosphorous oxychloride, polyamide-epichlorohydrin crosslinking agents (such as POLYCUP® 1884 crosslinking resin available from Hercules, Inc., Wilmington, Del.), anhydride containing polymers (such as SCRIPSET® 740 available from Hercules), cyclic amide condensates (such as SUNREZ® 700C available from Omnova), zirconium and titanium complexes such as ammonium zirconium carbonate, potassium zirconium carbonate, titanium diethanolamine complex, titanium triethanolamine complex, titanium lactate, titanium ethylene glycolate, adipic acid dihydrazide, di-epoxides such as glycerol diglycidyl ether and 1,4 butanediol diglycidyl ether, and polyepoxide compounds such as a polyamine/polyepoxide resin (a reaction product of 1,2-dichloroethane and epichlorohydrin), di-functional monomers such as N,N′-methylene bisacrylamide, ethylene glycol dimethacrylate and ethylene glycol diacrylate, dianhydrides, acetals, polyfunctional silanes, boron compounds such as sodium borate or borax, and combinations thereof.

It is within the scope of this invention for the hydroxy polymer crosslinker to react with the hydroxy polymer derivative. For example, if the hydroxy polymer is functionalized with carboxylic acid groups, these carboxylic acid groups can be reacted with polyamide-epichlorohydrin resins to form a crosslinked system. These hydroxy polymer crosslinkers exclude polymers containing carboxylic acid groups which need to react with the hydroxy polymer at a pH of 3 or lower. The low pH required for this type of crosslinker causes corrosion problems in the equipment and is not preferred.

Hydroxy polymer crosslinkers according to the present invention do not have emission issues. As defined herein, ‘emission issues’ refer to the release of a ‘substantial amount’ of volatile components during the curing process. For the present invention, a substantial amount is defined as where the volatile component is more than 25 mole percent of the crosslinker. Examples of emission issues include the release of ammonia when ammonium neutralized carboxylate functionalities are used in the crosslinking system (see, for example, U.S. Patent Publication No. 2005/0202224, which is incorporated by reference in its entirety herein) where the carboxylate functionality is neutralized to greater than 25 mole percent with ammonia.

In addition, both the hydroxy polymers and the hydroxy polymer crosslinkers do not include aldehyde functionalities (see, for example, U.S. Patent Publication Nos. 2007/0083004 and 2007/0167561, which are each incorporated by reference in their entireties herein) such glyoxal, since materials containing aldehydes tend to have toxicology issues.

In one embodiment, crosslinkers according to the present invention react with hydroxy polymers at a pH of around neutral. In a further embodiment, these crosslinkers do not react with the hydroxy polymers at ambient temperatures, and can be activated at elevated temperatures such as above 100° C. This lack of reaction between the crosslinker and the hydroxy polymer at ambient temperatures gives the aqueous binder system a longer pot life, which is an advantage during the manufacture of the composite. Useful crosslinkers can form non-reversible bonds which gives the binders long term stability. Useful crosslinkers include adipic/acetic mixed anhydride, sodium trimetaphosphate, sodium trimetaphosphate/sodium tripolyphosphate, polyamide-epichlorohydrin crosslinking agents, polyamine/polyepoxide resin, cyclic amide condensates, 1,4-butanediol diglycidyl ether, glycerol diglycidyl ether, ammonium zirconium carbonate, potassium zirconium carbonate, titanium diethanolamine complex, titanium triethanolamine complex, titanium lactate, titanium ethylene glycolate, sodium borate, dianhydrides and/or polyfunctional silanes.

The formaldehyde free binder of the present invention may be applied to the substrate in any number of ways. If the substrate is fiberglass, the binder is generally applied in the form of an aqueous solution by means of a suitable spray applicator for distributing the binder evenly throughout the formed fiberglass mat. Typical solids of the aqueous solutions can be from about 1 to about 50 percent. In one aspect, the solids content can be from about 2 to about 40 percent. In another aspect, the solids content can be from about 5 to about 25 percent by weight of the aqueous binder solution. If the binder solution is sprayed, the viscosity of the binder solution may determine the maximum level of solids in the binder solution. The binder may also be applied by other means known in the art such as airless spray, air spray, padding, saturating, and roll coating.

The composite is formed when the binder is applied to the substrate and cured. For purposes of this disclosure, “curing” refers to any process that can facilitate the crosslinking reaction between the hydroxy polymer and the crosslinker. Curing is typically achieved by a combination of temperature and pressure. A simple way to affect the cure is to place the binder and the substrate in a high temperature oven. Typically, a curing oven operates at a temperature of from 110° C. to 325° C. One of the advantages of the formaldehyde free binder system of this invention is that it cures at relatively low temperatures such as below 200° C. In another aspect the binder system cures below 150° C. The composite can cured in about 5 seconds to about 15 minutes. In another aspect, it can cure in about 30 seconds to about 3 minutes.

The binder can be applied in the form of an aqueous solution. The pH of the aqueous binder solution is greater than about 3. In one aspect, the pH of the binder solution is from about 3 to about 12. In another aspect, the pH of the binder solution is from about 4 to about 10. In even a further aspect, the pH of the binder solution is from about 6 to about 9. Cure temperature and pressure depends on the type and amount of crosslinker, type and level of catalyst used as well as the nature of the substrate. For example, higher pressures are utilized in the manufacture of MDF board as compared to insulation.

The amount of crosslinker in the formaldehyde free binder solution depends upon the type of crosslinker and the application in which the binder is being used. Weight percent of the crosslinker in the formaldehyde free binder can be from about 0.1 to about 70 percent. In another aspect, it can be from about 1 to about 50 percent. In even another aspect, the crosslinker weight percent can be from about 2 to about 40 percent.

An optional catalyst may be added to the binder formulation to allow the binder to cure at a faster rate or a lower temperature or a pH range closer to neutral. One skilled in the art will recognize that the catalyst chosen will depend on the crosslinker as well as the hydroxy polymer used. Likewise the amount of catalyst needed will depend on the crosslinker used as well as the hydroxy polymer used.

An additive may be added to the formaldehyde binder. For purposes of this invention an additive is defined as any ingredient which may be added to the binder to improve performance of the binder. These additives may include ingredients that give moisture, water or chemical resistance, as well as resistance to other environmental effects; and additives that give corrosion resistance as well as additives that enable the binder to adhere to the substrate. For example, if the composite is a fiberglass mat that is used in the production of flooring materials, it may be necessary for the fiberglass mat to adhere to the flooring material. A suitable hydrophobic additive may help with this surface adhesion. Examples of these additives include but are not limited to materials that can be added to the binder to provide functionality such as corrosion inhibition, hydrophobic additives to provide moisture and water repellency, additives for reducing leaching of glass, release agents, acids for lowering pH, anti-oxidants/reducing agents, emulsifiers, dyes, pigments, oils, fillers, colorants, curing agents, anti-migration aids, biocides, anti-fungal agents, plasticizers, waxes, anti-foaming agents, coupling agents, thermal stabilizers, flame retardants, enzymes, wetting agents, and lubricants. These additives can be about 20 weight percent or less of the total weight of the binder.

When the substrate is fiberglass, the hydroxy polymer can be derivatized with a reagent that introduces silane or silanol functionality into the hydroxy polymer. Conversely, an additive such as a small molecule silane may be introduced into the binder formulation before curing. This small molecule silane is chosen such that the organic part of the silane reacts with the hydroxy polymer under cure conditions while the silane or silanol portion reacts with the fiberglass substrate. This introduces a chemical bond between the binder and the substrate resulting in greater strength and better long term performance.

Preferred additives include “hydrophobic additives” that provides moisture, humidity and water resistance. For the purpose of this invention, hydrophobic additives can include any water repellant material. It can be a hydrophobic emulsion polymer such as styrene-acrylates, ethylene-vinyl acetate, poly siloxanes, fluorinated polymers such as polytetrafluoroethylene emulsions, polyethylene emulsions and polyesters. In addition, it can be a silicone or a silicone emulsion, wax or an emulsified wax or a surfactant. The surfactant itself can provide hydrophobicity, or it can be used to deliver a hydrophobic water insoluble material. The surfactant can be non-ionic, anionic, cationic or amphoteric. In one aspect, the surfactants are nonionic and/or anionic. Nonionic surfactants include, for example, alcohol ethoxylates, ethoxylated polyamines and ethoxylated polysiloxanes. Anionic surfactants include alkyl carboxylates and alkylaryl sulfonates, α-olefin sulfonates and alkyl ether sulfonates.

### EXAMPLES

The invention will now be described in further detail by way of the following examples.

### Example 1

Binder solutions of polyvinyl alcohol (CELVOL® 103, available from Celanese, Dallas, Tex.) and a polyamide-epichlorohydrin (POLYCUP 1884 available from Hercules, Inc., Wilmington, Del.) were tested as a binder for fiberglass mats at pH 8.20 g of CELVOL® 103 was slurried in 80 g of water and then heated at 90° C. for two hours to dissolve the polyvinyl alcohol. Polyvinyl alcohol was combined with the polyamide-epichlorohydrin resin in the ratios mentioned in the table below. This binder solution was then diluted to 5% solids. Glass microfiber filter paper sheets (20.3×25.4 cm, Cat No. 66227, Pall Corporation., Ann Arbor, Mich.) were dipped in the binder solution and run through a roll padder. The coated sheets were then cured at 175° C. for 10 minutes in an oven. The amount of binder applied was typically 16% of the weight of the filter paper. The cured sheets were cut into dog bone shaped coupons having a width of 1 cm in the center and soaked in water for 60 minutes. Tensile strength was then measured using an Instron equipped with self identifying tension load cell.

TABLE 1

| | Weight percent of | | |
|---|---|---|---|
| | crosslinker based | | Tensile |
| | on weight of | | Strength |
| Binder | binder | pH | (PSI) |
| Polyvinyl alcohol | 2 | 8 | 50 |
| (CELVOL ® 103) and | | | |
| polyamide- | | | |
| epichlorohydrin | | | |
| (POLYCUP 1884) | | | |
| crosslinker | | | |
| Polyvinyl | 10 | 8 | 108 |
| alcohol(CELVOL ® | | | |
| 103) and polyamide- | | | |
| epichlorohydrin | | | |
| (POLYCUP 1884) | | | |
| crosslinker | | | |

The data in the table above indicates that polyvinyl alcohol systems crosslinked with hydroxy polymer crosslinkers according to the present invention have excellent tensile strength. This is achieved at pH 8, and not at a low pH such as 3 that is prone to corrosion issues. Furthermore, there is no emission issues associated with the binder of Example 1.

### Example 2

The efficacy of a hydroxy polymer binder system is measured using the test procedure below—
1. Commercial glass wool having a binder (Ultimate) was taken and cut into small pieces. Approximately 15 to 20 g of glass wool was weighed in an aluminium pan and placed into an oven at 450° C. for at least three hours or until the weight is constant in order to eliminate the binder (the loss weight should be around 5-7%). The color of the glass wool turned from yellow to gray.
2. The glass wool fibers were placed into a 1000 mL jar containing 500 g of alumina balls. A powder was produced from the glass wool by placing the jar in a ball mill for about two minutes. The fibers were visible under a microscope using a magnification of 100.
3. The powder was then sifted.
4. A binder solution was prepared in a 100 mL beaker by combining 4 g of polyvinyl alcohol as cooked in Example 1 with 10 g of the powder prepared above and mixed well, resulting in a paste that was workable but did not flow.
5. 5 mm pellets were made from a small piece of the paste by using the rear end of a cork drill. The pellets were cured by placing them in a microwave oven at 500 W and drying them for 20 minutes. Alternatively, these pellets can be cured in an oven for 2 hours at 150° C.
6. The cured pellets were placed in a plastic bottle containing 100 ml of water. The bottle was then placed in a water bath set at 70° C. Samples were tested every 24 hours by taking a pellet from the bottle, drying it first with a paper towel and then once again in an oven at 100° C. for two hours. If the pellet is strong and cannot be crushed between one's fingers, the binder system is deemed to still be effective. The longer the pellet survives this test, the better the performance of the binder system.

Standard formaldehyde based binders (phenolic resin) survive 1 to 4 days in this test. Excellent binder systems may last up to 11 days. If the binding performance is below average, the samples disintegrate immediately.

A number of hydroxy polymers crosslinked with crosslinkers were tested according to the protocol detailed above. The data on these samples are listed in the table below.

TABLE 2

| | | | | POLYCUP ® | | SCRIPSET ® | | BACOTE ® | | ZIRMEL ® | |
|---|---|---|---|---|---|---|---|---|---|---|---|
| | Crosslinker | STMP | | 1884 | | SC740 | | 20 | | 1000 | |
| Hydroxy polymer | Weight percent of | 1% | | 3% | | 3% | | 3% | | 3% | |
| | crosslinker based | | | | | | | | | | |
| | on weight of binder | | | | | | | | | | |
| | | Days | pH | Days | pH | Days | pH | Days | pH | Days | pH |
| Polyvinyl alcohol | | >4 | 10.3 | >4 | 8.7 | >4 | 8.4 | >1 | 9.3 | >1 | 9.4 |
| (CELVOL ® 103) | | | | | | | | | | | |

STMP—sodium trimetaphosphate
POLYCUP ® 1884—polyamide-epichlorohydrin crosslinking agent, available from Hercules
SCRIPSET ® SC740—Ammonium solution of esterified styrene maleic-anhydride co-polymer, available from Hercules
BACOTE ® 20—ammonium zirconium carbonate solution, available from MEL/MEI Chemicals
ZIRMEL ® 1000—potassium zirconium carbonate, available from MEL/MEI Chemicals

The data in the table indicates that hydroxy polymers of this invention perform as well as formaldehyde based binder systems since the pellets made from the formaldehyde based binder system would last one to four days in this test. Additionally, hydroxy polymer systems according to the present invention cure in a neutral pH range, do not have any emission issues, and do not utilize aldehyde-based crosslinking agents.

Although the present invention has been described and illustrated in detail, it is to be understood that the same is by way of illustration and example only, and is not to be taken as a limitation. The spirit and scope of the present invention are to be limited only by the terms of any claims presented hereafter.

We claim:

1. Composite comprising:
a formaldehyde free binder comprising one or more hydroxy polymers and one or more hydroxy polymer crosslinkers; and
a substrate treated with the binder.

2. Composite according to claim 1, wherein the substrate is a mineral wool or lignocellulosic substrate.

3. Composite according to claim 2, wherein the substrate is mineral wool and the mineral wool is fibreglass, ceramic fibres, stone wool or rock wool.

4. Composite according to claim 2, wherein the substrate is lignocellulosic and the lignocellulosic substrate is wood.

5. Composite according to claim 1, wherein the hydroxyl polymer is selected from the group consisting of homopolymers and copolymers containing vinyl alcohol functionalities, polymers containing hydroxy alkyl(meth)acrylates moieties, and mixtures thereof.

6. Composite according to claim 1, wherein the hydroxy polymer is polyvinyl alcohol.

7. Composite according to claim 1, wherein the hydroxy polymer crosslinker is chosen from adipic/acetic mixed anhydride, epichlorohydrin, sodium trimetaphosphate, sodium trimetaphosphate/sodium tripolyphosphate, and phosphorous oxychloride, polyamide-epichlorohydrin crosslinking agents, anhydride containing polymers, cyclic amide condensates, zirconium and titanium complexes, adipic acid dihydrazide, di-epoxides and polyepoxide compounds, di-functional monomers, dianhydrides, acetals, polyfunctional silanes, boron compounds and combinations thereof.

8. Composite according to claim 1, wherein the weight percent of the hydroxy polymer crosslinker in the formaldehyde free binder is from about 0.1 to about 70 percent, based on weight of the binder.

9. Composite according to claim 1, wherein the formaldehyde free binder further comprises an additive.

10. Composite according to claim 9, wherein the additive is a hydrophobic additive.

11. Composite according to claim 1, wherein the weight percent of the binder is less than 50 weight percent, based on total weight of the composite.

12. Composite of claim 1, wherein the hydroxy crosslinker and the hydroxy polymer of the formaldehyde free binder are free of aldehydes.

13. Composite of claim 12, wherein the amount of volatile components released is about 25 mole percent or less of the crosslinker when cured.

14. Method of forming a composite comprising:
preparing a formaldehyde free binder from one or more hydroxy polymers and one or more hydroxy polymer crosslinkers;
depositing the formaldehyde free binder onto a substrate; and
curing the substrate.

15. Method of forming a composite according to claim 14, wherein the substrate is a mineral wool or lignocellulosic substrate.

16. Method of forming a composite according to claim 14, wherein the weight percent of the hydroxy polymer crosslinker in the formaldehyde free binder is from about 0.1 to 70 percent.

17. Method of forming a composite according to claim 14 further comprising applying the binder to the substrate as an aqueous solution, wherein the pH of the aqueous solution is greater than 3.
